(19) United States
(12) Patent Application Publication
(10) Pub. No.: US 2022/0032438 A1
(43) Pub. Date: Feb. 3, 2022

(54) POWER TOOL POWERED BY POWER OVER ETHERNET

(71) Applicant: APEX BRANDS, INC., Apex, NC (US)

(72) Inventor: Rolf Reitz de Swardt, Blythewood, SC (US)

(21) Appl. No.: 17/276,661

(22) PCT Filed: Sep. 23, 2019
(86) PCT No.: PCT/US2019/052337

§ 371 Date: Mar. 16, 2021

Related U.S. Application Data
(60) Provisional application No. 62/751,332, filed on Oct. 26, 2018.

(51) Int. Cl. B25F 5/00; H04L 12/10

(52) U.S. Cl. CPC B25F 5/00; H04L 12/10

(57) ABSTRACT

A hand-held power tool may include a motor, an end effector operably coupled to the motor and operable responsive to operation of the motor, and a control unit configured to control operation of the motor based at least in part on data communicated to the control unit from an external network. Power to the motor and the data communicated to the control unit from the external network may both be provided via a single cable.

### TECHNICAL FIELD

Example embodiments generally relate to power tools and, in particular, relate to systems and architectures for enabling such tools to be powered via power over Ethernet (POE).

### BACKGROUND

Power tools are commonly used across all aspects of industry and in the homes of consumers. Power tools are employed for multiple applications including, for example, drilling, tightening, sanding, and/or the like. Handheld power tools are often preferred, or even required, for jobs that require a high degree of freedom of movement or access to certain difficult to reach objects.

Handheld power tools may have a number of different power sources. In this regard, for example, compressed air, mains electric power or batteries form common power sources. The power sources enable robust tools with multiple corresponding different uses to be put into action by operators in a number of different contexts.

In some specific industries, the operation and use of power tools may be subject to particular constraints. The constraints may include constraints from an ergonomic perspective relative to size and weight. In some cases, constraints may be introduced from an access perspective relative to reaching a required area for operation. In some other cases, constraints may be introduced from a process control perspective to ensure that the correct tool is being used in the correct manner. Still other constraints may relate to required connectivity of the power tools to particular sources of power and/or the Internet or other communication networks.

Particularly for power tools that require connectivity to communication networks, such communication may be vital to the operation of the tools. For example, various operationally critical programs may be provided to the tool (or updated at the tool) via the Internet and/or the operation of the tool may be managed or monitored via the Internet. Although it may be possible to engage in wireless communication while also powering the tool via battery to greatly enhance mobility due to a completely cordless context being created, the batteries may be heavy and some environments may be challenging for wireless communications. Additionally, low voltage, corded power tools may require a power supply that converts high voltage alternating current (AC) to lower voltage direct current (DC) power. High voltage AC powered, corded tools may require an AC-DC converter inside the tool and a low voltage communication board plus additional wires to connect to the Internet. Thus, the weight and complexity of such tools can be drastically increased. Meanwhile, if a wired connection to the power tool is acceptable or desired, it may be the case that the power tool is connected by one cable to the Internet, while receiving power from a separate cable.

Accordingly, it may be desirable to continue to develop improved mechanisms by which to power and communicatively couple power tools to the Internet or other communication networks.

### BRIEF SUMMARY OF SOME EXAMPLES

Some example embodiments may enable the provision of a hand-held power tool. The power tool may include a motor, an end effector operably coupled to the motor and operable responsive to operation of the motor, and a control unit configured to control operation of the motor based at least in part on data communicated to the control unit from an external network. Power to the motor and the data communicated to the control unit from the external network may both be provided via a single cable.

In another example embodiment, an accumulator for a hand-held power tool is provided. The power tool may include a motor, an end effector operably coupled to the motor and operable responsive to operation of the motor, and a control unit configured to control operation of the motor based at least in part on data communicated to the control unit from an external network. Power to the motor and the data communicated to the control unit from the external network are both provided via a single cable. The accumulator may be operably coupled between the single cable and the motor to enable power available via the single cable to be provided to the motor. The accumulator may be configured to charge when power demand by the motor is less than power available via the single cable.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a functional block diagram of a system that may be useful in connection with providing a power tool according to an example embodiment;

FIG. 2 illustrates a functional block diagram of a power tool according to an example embodiment; and

FIG. 3 illustrates a diagram of current versus time for a particular power tool in accordance with an example embodiment;

FIG. 4 illustrates a diagram of charge versus time for the power tool of the example of FIG. 3;

FIG. 5 illustrates a diagram of current versus time for a power tool with a mismatch between power available and power demanded during steady state operation of the power tool in accordance with an example embodiment;

FIG. 6 illustrates a diagram of charge versus time for the power tool of the example of FIG. 5;

FIG. 7 illustrates a diagram of current versus time for a power tool with a different mismatch between power available and power demanded during steady state operation of the power tool in accordance with an example embodiment; and

FIG. 8 illustrates a diagram of charge versus time for the power tool of the example of FIG. 7.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

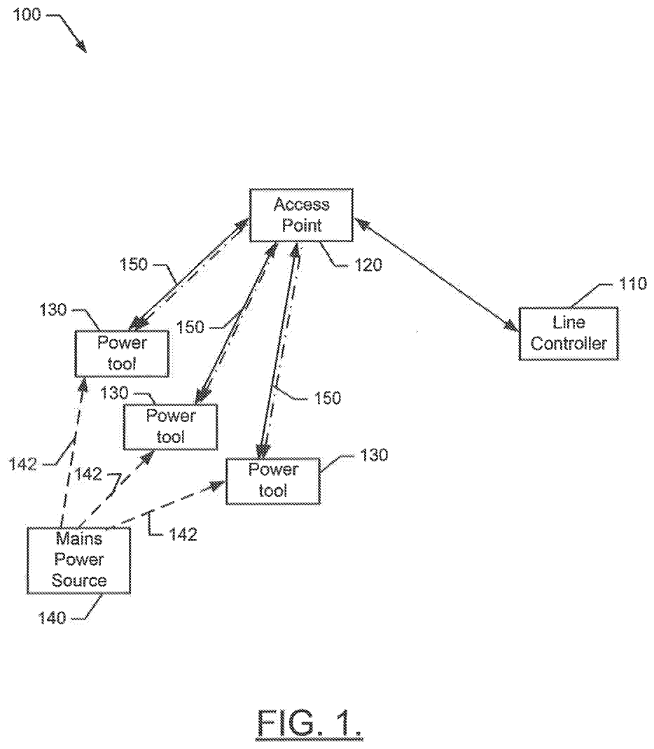

As indicated above, some example embodiments may relate to the provision of power tools that also have the ability to receive both power and data connection via a single corded connection or bus communication. Such power tools may also have superior properties with respect to allowing for process controls to be effectively implemented while avoiding multiple corded connections or access to mains power supplies. In this regard, for example, power over Ethernet (POE) may be used to provide power and data connection for the power tool. Thus, for example, the corresponding power tool may be fully ready for integration and use within an Industry 4.0 and Internet of Things (IOT) context. FIG. 1 illustrates a functional block diagram of a system that may be useful in connection with providing a context for operation of such a power tool according to an example embodiment. However, it should be appreciated that example embodiments may also be practiced within other systems or contexts. Thus, FIG. 1 should be appreciated as merely one non-limiting example that is used to describe the general concept of providing power to a power tool via POE.

As shown in FIG. 1, a system 100 of an example embodiment may include a line controller 110, an access point 120 and one or more power tools 130. The line controller 110 may be a computer, server, or other processing circuitry that is configurable to communicate with the power tools 130 via the access point 120 to provide process controls. The line controller 110 may therefore include one or more processors and memory that may be configurable based on stored instructions or applications to direct operation of the power tools 130. As such, the line controller 110 may provide guidelines, safety limits, specific operating instructions, and/or the like to various ones of the power tools.

The access point 120 may be configured to interface with the line controller 110 and the power tools 130 via Ethernet communication, or another computer networking technology. As such, for example, the access point 120 may be a component of infrastructure or a framework forming a local area network (LAN) for communication with other components of the network. However, it should be appreciated that the access point 120 may alternatively be a portion of a metropolitan area network (MAN), wide area network (WAN), or any other communication network. As such, in some cases, the power tool 130 may be a power tool belonging to an individual and no line controller need be employed at all. In such a case, the power tool 130 may be operably coupled to an Ethernet port (or similar communication port) at the access point 120 where it is understood that the access point 130 may be located at the home, office, or another public or private location. Thus, the line controller 110 may be entirely optional in some cases. However, when employed, each of the access point 120, the power tools 130 and the line controller 110 may include a communications module and corresponding transmit/receive circuitry for facilitating communication over the network. In some cases, the communications over the network may be secured with encryption and/or authentication techniques being employed by the communications modules at the respective components of the network.

FIG. 1 illustrates three power tools 130, but it should be appreciated that the system 100 may operate with one power tool or may more than three power tools. Thus, three power tools are merely shown to exemplify the potential for multiplicity relative to the power tools 130 that could be employed with example embodiments. The power tools 130 may be configured to employ Ethernet communication with the line controller 110 on a one way (e.g., from the line controller 110 to the power tools 130) or two-way basis. As such, for example, in some cases, usage data for logging or activity tracking may be provided back to the line controller 110 from the power tools 130 responsive to operation of the power tools 130. Moreover, in some cases, the two-way communication may be employed for step-by-step or activity based interactive instruction provision that can be conducted on a real-time basis.

In a typical situation, as noted above, the power tools 130 may be operably coupled to the access point 120 via a first cable and may be powered via a mains power source 140 via a second cable (i.e., a power cable 142). Although heavy battery powered tools could be used as an alternative, each of those situations has drawbacks. Accordingly, to eliminate the need for the power cable 142 (and therefore multiple cables being attached to the power tools 130), some example embodiments may provide both data connection (represented by the solid line between the access point 120 and the power tools 130) and power connection (represented by the dot-dashed line between the access point 120 and the power tools 130) from the access point 120 to the power tool 130 via a single data/power cable 150 (e.g., a standard Ethernet cable, or another analog or bus communication cable such as a CAT 5 cable, RJ 45 cable and/or the like). Accordingly, each instance of the power tool 130 may have a corresponding instance of the data/power cable 150 such that there is only one cable that connects to any given power tool. The system 100 of FIG. 1 can therefore operate without any need for the power cables 142 that would otherwise connect the power tools 130 to the mains power source 140.

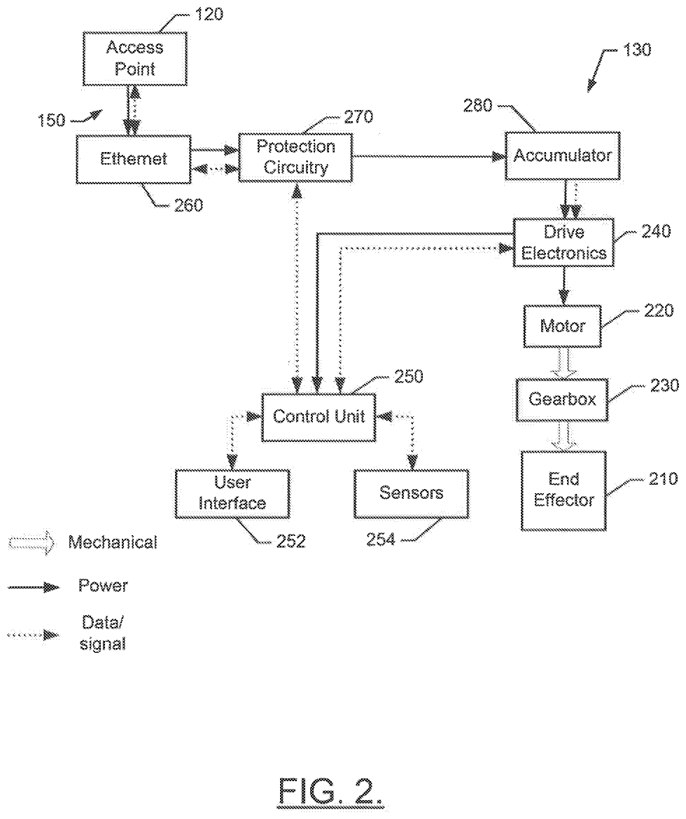

FIG. 2 illustrates a block diagram of components that may be employed in one of the power tools 130 in accordance with an example embodiment. As shown in FIG. 2, the power tool 130 may include an end effector 210 that is driven by a motor 220 via a gearbox 230. In various example embodiments, the end effector 210 may be a fastening tool, a material removal tool, an assembly tool, or the like. Thus, for example, the end effector 210 may be a nutrunner, torque wrench, socket driver, screw driver, bit driver, drill, riveter, polisher, cutting device, grinder, and/or the like. The gear box 230 may include gearing and/or other drive components that convert the rotational forces transmitted by the motor 220 to perform the corresponding function of the end effector 210 for fastening, material removal and/or assembly.

The motor 220 may be an AC motor that is operably coupled to drive electronics 240 (e.g., a servo drive in the form of a servomechanism). However, it should be appreciated that certain types of power tools 130 may use different motors including, for example, 3 phase brushless DC motor (BLDC Motor), 3 phase Permanent Magnet Synchronous motor (PMSM), Brushed DC motors or other types of AC motors. Thus, the motor 220 of this embodiment is merely one example. The drive electronics 240 may be operably coupled to a control unit 250 that is configured to control the operation of the drive electronics 240. In some embodiments, the drive electronics 240 (or another similar component driving the motor 220) may include an inverter to drive 3 phase BLDC or PMSM motors, and may include a converter configured to step voltages up or down as desired. In some cases, the converter may be a DC-DC step down converter configured to reduce 44 V DC to other voltages needed elsewhere in the power tool 130, such as for powering the control unit 250 or other components. Moreover, in some cases, the step down converter could be used to charge smaller sized rechargeable batteries used for auxiliary components or other components operable via rechargeable batteries. It should also be appreciated that the power tool 130 may include any desirable number of power converters, where each power converter provides a conversion from a given level of voltage to another level of voltage desired for a particular function or provides a conversion from DC to AC or AC to DC.

The control unit 250 may be configured to access or execute operating instructions correspondingly for the tool type of the power tool 130. As such, for example, the control unit 250 may be configured to provide control signals or other operating instructions to the drive electronics 240 to ultimately cause and control operation of the end effector 210. The instructions may be stored locally (e.g., in onboard memory) or may be provided from external sources (e.g., via the line controller 110).

In an example embodiment, the control unit 250 may be further operably coupled to a user interface 252 and/or sensors 254. The sensors 254 may gather data regarding any of numerous possible parameters associated with operation of the end effector 210. For example, the sensors 254 may gather data associated with revolutions per minute (RPM) at which the end effector 210 is driven, the torque, the driving current or voltage applied to the motor, or any of numerous other measurable parameters associated with the context or operation of the power tool 130. The user interface 252 may include, for example, a display, one or more buttons or keys (e.g., function buttons), and/or other input/output mechanisms (e.g., keyboard, microphone, trigger, speaker, cursor, joystick, lights and/or the like). The user interface 252 may display or otherwise provide an indication of certain parameters associated with operation of the power tool 130 that have been measured by the sensors 254. However, in some cases, the user interface 252 may be relatively simple and merely indicate that power is on or available, and enable the operator to actuate or otherwise cause operation of the end effector 210.

In an example embodiment, programs, instructions, control signals and/or the like may be provided to the control unit 250 via an Ethernet port 260 (or similar) connection. These programs, instructions or control signals (if provided) may be received from the line controller 110 and the access point 120 of FIG. 1 in some cases. Accordingly, for example, the control unit 250 may be operably coupled to the access point 120 via the data/power cable 150 discussed above to provide POE for the power tool 130. However, in some cases, the power tool 130 may include protection circuitry 270 to protect the power tool 130 from any power surges or other electrical faults that may occur at the Ethernet port 260, or the device or devices to which the Ethernet port 260 is otherwise operably coupled. As such, data signaling for the control unit 250 may be provided from the Ethernet port 260 via the protection circuitry 270, and power may be provided from the Ethernet port 260 also via the protection circuitry 270. The protection circuitry 270 may be configured to provide electrical isolation using transistors, transformers, switches or any other suitable protection devices known in the art. The protection circuit 270 may also be configured to protect the internet side from power surges or electrical faults in the power tool 130. The protection circuit 270 may also be configured to extract the power from the combined Ethernet power and data conductors. Power may then be transmitted on the data conductors by applying a common voltage to each pair. Because twisted-pair Ethernet uses differential signaling, this method of applying power may not interfere with data transmission. The common-mode voltage may be extracted using the center tap of a standard Ethernet pulse transformer.

In an example embodiment, the power from the Ethernet port 260 (and therefore also via the access point 120) may be readily available at standard levels defined by industry standards such as, for example, the IEEE 802.3af-2003 POE standard. Thus, for example, up to 15.4 W of DC power with a minimum of 44 V DC, 350 mA, and 12.95 W available at the power tool 130 (due to losses in the cabling) may be available at each instance of the Ethernet port 260. However, higher power levels may be available as new POE standards are developed.

If an example is considered where 350 mA is continuously available over POE for the power tool 130, the end effector 210 may be expected to be able to operate continuously for any loads drawing 350 mA or less. This may be suitable for certain grinding or polishing operations where the load is relatively constant over the entire use cycle of the power tool 130. However, for certain tightening operations, the load may increase at the end of the use cycle when the screw or fastening device is seated and ready to be torqued for completion of the tightening operation. In such a case, if the steady state load during tightening was 350 mA, the screw or fastening device may be able to be applied to the point of initial seating, but may not be torqued beyond that point. This may result in an unacceptable situation and leave POE as a completely unworkable solution for tightening operations or other operations where an uneven power draw requirement exists or where, for example, a power spike is necessary or desirable at some point (or points) during a use cycle. In order to equip the power tool 130 to handle this situation while still being operable via POE, some example embodiments may further provide an accumulator 280 between the Ethernet port 260 and the drive electronics 240. If protection circuitry 270 is employed, the accumulator 280 may be provided between the protection circuitry 270 and the drive electronics 240, as shown in FIG. 2.

The accumulator 280 may be configured to accumulate a power reserve whenever the available power at the Ethernet port 260 is higher than the load generated by the operation of the end effector 210. The accumulator 280 may be further configured to supply power (e.g., from the power reserve) for operation of the end effector 210 when load requirements for operation of the end effector 210 exceed the available power that is nominally available via POE. In an example embodiment, the accumulator 280 may include one or more rechargeable batteries (e.g., lithium ion or other batteries). However, in other examples, the accumulator 280 may be embodied as one or more capacitors, supercapacitors, or ultracapacitors. Any other energy storage device that is suitable for storing an energy reserve that can be readily delivered upon demand may also be employed as the accumulator 280.

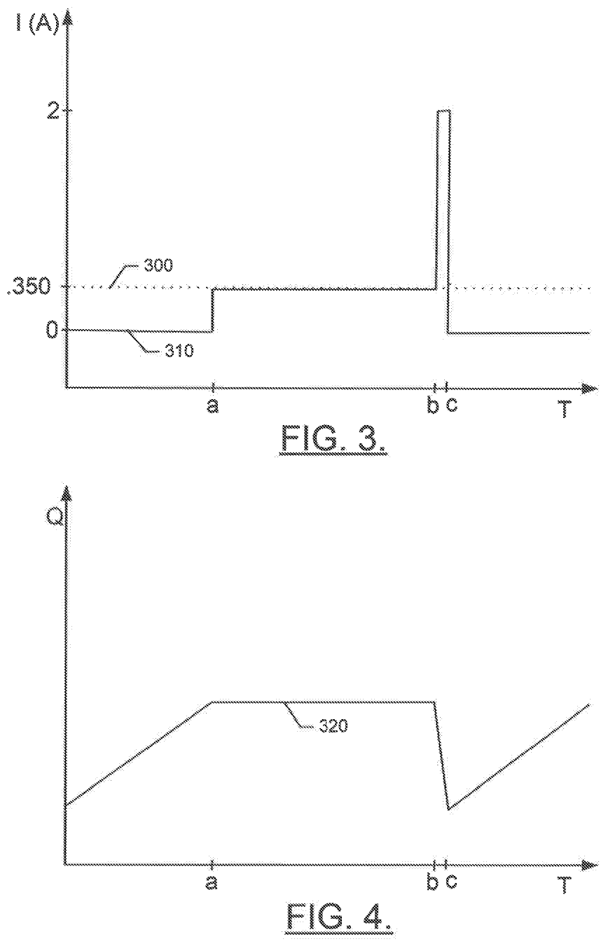

As noted above, certain types of power tools may require high power levels (particularly in short bursts). For example, riveters, screw drivers and nut runners may require a burst of high power to perform their respective operations. Some, such as the screw drivers or nut runners, may otherwise have a relatively low power requirement until the end of a use cycle is reached. The accumulator 280 provides a method by which to handle these short duration power requirement peaks. FIGS. 3-8 illustrate some examples of how the accumulator 280 may function in some example embodiments. Of note, the magnitudes of the charge and the discharge rates, and of the current values shown, are merely examples over the periods shown, and are not meant to be to scale, but instead to illustrate the concepts being demonstrated.

In this regard, referring first to FIG. 3, assume that the POE is able to provide about 350 mA on a relatively continuous basis. Current profile 300 illustrates the continuously available current that can be directly provided from the Ethernet port 260 to the motor 220 of FIG. 2. FIG. 3 also illustrates a load profile 310 for a screw driver, showing current drawn by the screw driver (e.g., as one example of the power tool 130) over a period of time representing one use cycle. It should be appreciated, however, that the screw driver may be operated over a number of repeated cycles. This may be easily accomplished so long as the accumulator 280 has sufficient power reserve to supply any instantaneous need for additional power. FIG. 4 illustrates a charge profile 320 for the accumulator 280 over the same period of time illustrated in FIG. 3.

As can be seen in FIG. 3, the screw driver is initially off, and draws no current from time T=0 to T=a. During this time, the current available from the POE provided through the Ethernet port 260 (e.g., 350 mA) can all be used to charge the accumulator 280. Thus, from time T=0 to T=a, the accumulator 280 charges at a maximum charge rate. At time T=a, the screw driver is powered on and driving of the screw commences. In this example, the screw driver draws about 350 mA from time T=a to T=b. Accordingly, during this time period the state of charge of the accumulator 280 remains relatively constant or unchanged as substantially all of the POE provided through the Ethernet port 260 is provided for driving the end effector 210.

At time T=b, the screw is driven to the point at which the screw is seated, and therefore tightening of the screw begins. The tightening of the screw may increase the current drawn by the motor 220 to a value that could be significantly larger than the steady state current draw. Accordingly, a spike in current draw can be seen from time T=b to T=c, at which time the screw is fully tightened and the use cycle ends. During the spike in current draw, a rapid discharge rate can be seen in FIG. 4. After time T=c, the current draw returns to zero, and the accumulator 280 charges again at the maximum charge rate.

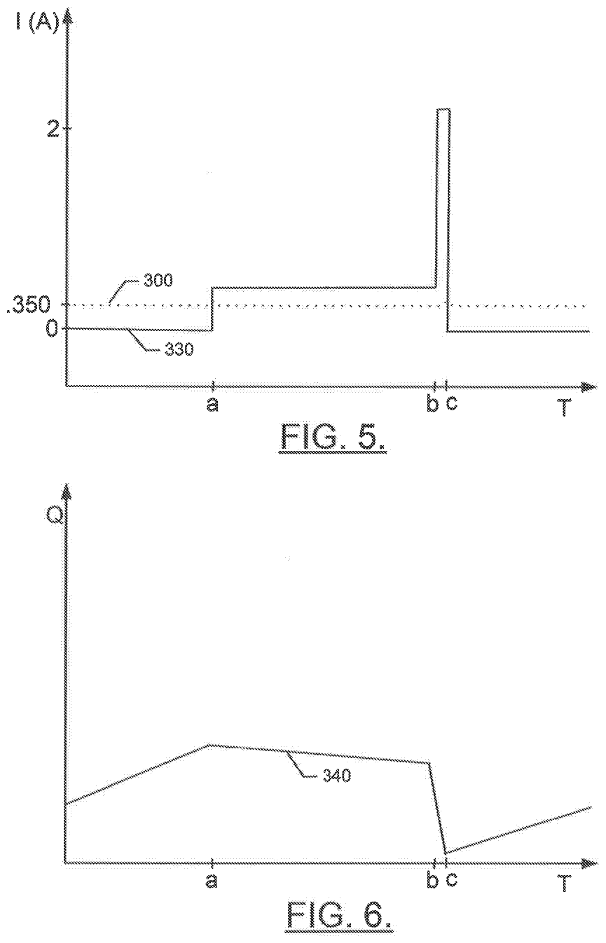

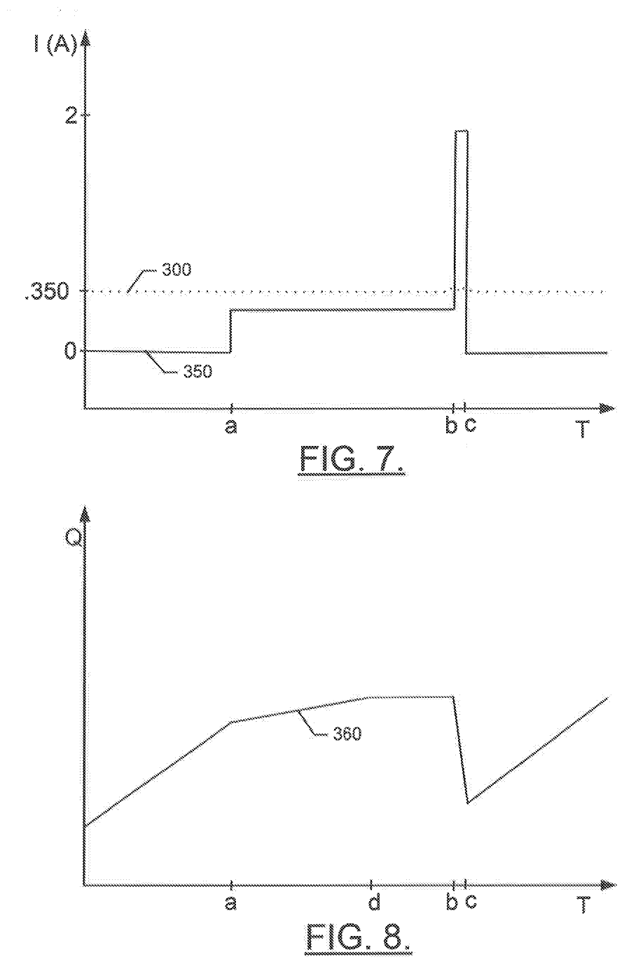

FIGS. 3 and 4 illustrate a situation where there is essentially a balance of the amount of power available via POE and the power required to operate the screw driver during steady state operation. However, some situations may not reflect such a balanced condition. Accordingly, FIGS. 5 and 6 illustrate a situation where such balance does not exist due to the steady state power requirement being higher than the power available via POE. Meanwhile, FIGS. 7 and 8 illustrate a situation where such balance does not exist due to the steady state power requirement being less than the power available via POE.

In the example of FIGS. 5 and 6, the same current profile 300 illustrates the continuously available current that can be directly provided from the Ethernet port 260 to the motor 220 of FIG. 2. However, the load profile 330 for the screw driver shows that current drawn by the screw driver from time T=a to T=b is higher than the available current via POE. This correspondingly changes the charge profile 340 for the accumulator 280 over the same period of time illustrated in FIG. 5.

As mentioned above, the screw driver is initially off, and draws no current from time T=0 to T=a. During this time, the current available from the POE provided through the Ethernet port 260 (e.g., 350 mA) can all be used to charge the accumulator 280 and from time T=0 to T=a, the accumulator 280 charges at a maximum charge rate. At time T=a, when the screw driver is powered on and driving of the screw commences, the screw driver draws more than the 350 mA available from POE from time T=a to T=b. Accordingly, during this time period, the accumulator 280 must discharge slightly to make up for the deficit in power relative to that which could be provided via POE.

At time T=b, the screw is driven to the point at which the screw is seated, and therefore tightening of the screw begins. The tightening of the screw increases the current drawn by the motor 220 to a value even larger than the steady state current draw. Accordingly, a spike in current draw is seen from time T=b to T=c, at which time the screw is fully tightened and the use cycle ends. During the spike in current draw, a rapid discharge rate can be seen in FIG. 6 (as in FIG. 4). However, the charge approaches nearer to zero. If the charge in the accumulator 280 had reached zero, then the screw driver could only operate (if at all) at the maximum current provided via POE of 350 mA. After time T=c, the current draw returns to zero, and the accumulator 280 charges again at the maximum charge rate.

In the example of FIGS. 7 and 8, the same current profile 300 illustrates the continuously available current that can be directly provided via POE from the Ethernet port 260 to the motor 220 of FIG. 2. However, the load profile 350 for the screw driver shows that current drawn by the screw driver from time T=a to T=b is lower than the available current via POE. This correspondingly changes the charge profile 360 for the accumulator 280 over the same period of time illustrated in FIG. 7.

As mentioned above, the screw driver is initially off, and draws no current from time T=0 to T=a. During this time, the current available from the POE provided through the Ethernet port 260 (e.g., 350 mA) can all be used to charge the accumulator 280 and from time T=0 to T=a, the accumulator 280 charges at a maximum charge rate. At time T=a, when the screw driver is powered on and driving of the screw commences, the screw driver draws less than the 350 mA available from POE from time T=a to T=b. Accordingly, during this time period, the accumulator 280 continues to be charged, but at a slower rate. Thus, the charging rate from time T=a to T=b is less than the charging rate from time T=0 to T=a. However, at time T=d, the accumulator 280 may reach full charge. At full charge, the accumulator 280 may no longer charge, but the screw driver may continue to draw the steady state current that was drawn before time T=d.

At time T=b, the screw is driven to the point at which the screw is seated, and therefore tightening of the screw begins. The tightening of the screw increases the current drawn by the motor 220 to a value larger than the steady state current draw. Accordingly, a spike in current draw is seen from time T=b to T=c, at which time the screw is fully tightened and the use cycle ends. During the spike in current draw, a rapid discharge rate can be seen in FIG. 8 (as in FIGS. 4 and 6). After time T=c, the current draw of the motor 220 returns to zero, and the accumulator 280 charges again at the maximum charge rate.

As can be appreciated from the examples shown in FIGS. 3-8, the rates of charging, discharging, and the magnitudes of peak and steady state current draws for any particular power tool, along with the corresponding time periods for which such values apply, will play a significant role in the ability of the power tool 130 to perform repeat operations or cycles where the power boosting capability of the accumulator 280 is required. Moreover, time between cycles will be dictated based on the same factors. However, it should be appreciated that the accumulator 280 provides significant flexibility in enabling the power tool 130 to exceed (even by relatively large amounts (e.g., orders of magnitude increases in current)) the steady state or continuously available levels of power that can be delivered by POE. Accordingly, powering devices while using the same cable for data and signaling relative to control of such devices can all be accomplished via POE or a similar bus communication paradigm.

In order to actuate the accumulator 280, some embodiments may use the same actuator or trigger that otherwise actuates the power tool 130. In such cases, for example, the mismatch between power available at via POE and power required by the drive electronics 240 or motor 220 may simply determine whether the accumulator 280 charges or discharges. However, in some cases, the power tool 130 may be fitted with a boost actuator that, when actuated, causes the accumulator 280 to generate a boost discharge signal to apply to the drive electronics 240 or motor 220 to cause a spike in power provision to the drive electronics 240 or motor 220. In an example embodiment, the boost actuator may only be effective from steady state operation conditions. In other words, the boost actuator may not be operable unless the drive electronics 240 or motor 220 is already operational and in steady state operation. However, in other cases, the boost actuator may be actuated regardless of the prior state of operation of the power tool 130. The boost actuator (if employed) and the trigger or other actuator for normal operation of the power tool 130 may each be portions of the user interface 252.

In some cases, the power tool 130 may provide an indication to the operator that power available at via POE is less than power required by the drive electronics 240 or motor 220. Of course, the operator may also receive an indication that power available via POE is greater than power required by the drive electronics 240 or motor 220. A state of charge of the accumulator 280 may also be communicated to the operator. In each case, the user interface 252 may include lights, a screen or other haptic, audible or visual mechanisms by which to provide indications of power mismatch and/or state of charge to the operator. The indications may be very simple, such as a light that changes color to indicate charging or discharging of the accumulator 280. However, in other cases, the indications may provide measurements (e.g., provided via the sensors 254) of the amount of charging or discharging that is occurring at any given time. In an example embodiment, a state of charge of the accumulator may also be indicated simply (e.g., with only a full charge, no charge, or intermediate state indicated) or in a more complex manner (e.g., via a percentage of full charge being indicated to the operator via the user interface 252).

Accordingly, some example embodiments may provide a hand-held power tool, which may include a motor, an end effector operably coupled to the motor and operable responsive to operation of the motor, and a control unit configured to control operation of the motor based at least in part on data communicated to the control unit from an external network. Power to the motor and the data communicated to the control unit from the external network may both be provided via a single cable.

The power tool described above may be augmented or modified by altering individual features mentioned above or adding optional features. The augmentations or modifications may be performed in any combination and in any order. For example, in some cases, the end effector may be configured to execute material removal, component assembly, or component tightening. In an example embodiment, the power tool may further include an Ethernet port to which the single cable is operably coupled, and at least 12.95 W of power may be available at the Ethernet port. In some cases, the power tool may further include an accumulator configured to charge when power demand by the motor is less than power available via the single cable. In an example embodiment, the accumulator may be configured to discharge when power demand by the motor is greater than power available via the single cable. In some cases, the accumulator may include one or more rechargeable batteries. In an example embodiment, the accumulator may include one or more capacitors, supercapacitors or ultracapacitors. In some cases, the accumulator may be configured to discharge responsive to actuation of a boost actuator. In an example embodiment, the accumulator may be configured to discharge responsive to actuation of a same actuator that actuates operation of the end effector when power demand by the motor is greater than power available via the single cable. In some cases, the power tool may further include a user interface, and the user interface may be configured to indicate a state of charge of the accumulator. In an example embodiment, power available via the single cable may be at least 15.4 W of DC power, 44 V DC, and 350 mA. In some cases, the data communicated may include instructions for the control unit to direct operation of the power tool. In an example embodiment, the instructions may be provided from a line controller operably coupled to the power tool via an access point at which power over Ethernet (POE) is provided to the power tool via the single cable.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A hand-held power tool comprising:
a motor;
an end effector operably coupled to the motor and operable responsive to operation of the motor; and
a control unit configured to control operation of the motor based at least in part on data communicated to the control unit from an external network,
wherein power to the motor and the data communicated to the control unit from the external network are both provided via a single cable.

2. The power tool of claim 1, wherein the end effector is configured to execute material removal, component assembly, or component tightening.

3. The power tool of claim 2, further comprising an Ethernet port to which the single cable is operably coupled, and wherein at least 12.95 W of power is available at the Ethernet port.

4. The power tool of claim 1, further comprising an accumulator configured to charge when power demand by the motor is less than power available via the single cable.

5. The power tool of claim 4, wherein the accumulator is configured to discharge when power demand by the motor is greater than power available via the single cable.

6. The power tool of claim 5, wherein the accumulator comprises one or more rechargeable batteries.

7. The power tool of claim 5, wherein the accumulator comprises one or more capacitors, supercapacitors or ultracapacitors.

8. The power tool of claim 4, wherein the accumulator is configured to discharge responsive to actuation of a boost actuator.

9. The power tool of claim 4, wherein the accumulator is configured to discharge responsive to actuation of a same actuator that actuates operation of the end effector when power demand by the motor is greater than power available via the single cable.

10. The power tool of claim 4, further comprising a user interface, the user interface being configured to indicate a state of charge of the accumulator.

11. The power tool of claim 1, wherein power available via the single cable is at least 15.4 W of DC power, 44 V DC, and 350 mA.

12. The power tool of claim 11, wherein the data communicated comprises instructions for the control unit to direct operation of the power tool.

13. The power tool of claim 12, wherein the instructions are provided from a line controller operably coupled to the power tool via an access point at which power over Ethernet (POE) is provided to the power tool via the single cable.

14. An accumulator for a hand-held power tool comprising a motor, an end effector operably coupled to the motor and operable responsive to operation of the motor, and a control unit configured to control operation of the motor based at least in part on data communicated to the control unit from an external network,
wherein power to the motor and the data communicated to the control unit from the external network are both provided via a single cable,
wherein the accumulator is operably coupled between the single cable and the motor to enable power available via the single cable to be provided to the motor, and
wherein the accumulator is configured to charge when power demand by the motor is less than power available via the single cable.

15. The accumulator of claim 14, wherein the accumulator is configured to discharge when power demand by the motor is greater than power available via the single cable.

16. The accumulator of claim 15, wherein the accumulator comprises one or more rechargeable batteries.

17. The accumulator of claim 15, wherein the accumulator comprises one or more capacitors, supercapacitors or ultracapacitors.

18. The accumulator of claim 14, wherein the accumulator is configured to discharge responsive to actuation of a boost actuator.

19. The accumulator of claim 14, wherein the accumulator is configured to discharge responsive to actuation of a same actuator that actuates operation of the end effector when power demand by the motor is greater than power available via the single cable.

20. The accumulator of claim 14, wherein the power tool further comprises a user interface, and
Wherein the user interface is configured to indicate a state of charge of the accumulator.
